(19) United States
(12) Patent Application Publication
(10) Pub. No.: US 2015/0333394 A1
(43) Pub. Date: Nov. 19, 2015

(54) DEVICE AND METHOD FOR SURFACE POSITIONING OF ANTENNAS

(71) Applicants: Phil Nash, Xenia, OH (US); Juan Zavala, Temecula, CA (US)

(72) Inventors: Phil Nash, Xenia, OH (US); Juan Zavala, Temecula, CA (US)

(21) Appl. No.: 14/714,206

(22) Filed: May 15, 2015

Related U.S. Application Data
(60) Provisional application No. 61/994,264, filed on May 16, 2014.

(51) Int. Cl. H01Q 1/38; H01Q 1/24

(52) U.S. Cl. CPC H01Q 1/38; H01Q 1/24

(57) ABSTRACT

Systems and methods for providing antennas for transmission and reception of radio frequency communications. More particularly, implementations of the present invention relate to a device and method for positioning antennas on surfaces encasing or surrounding an electronic device such as the rear of a flat panel display television or a laptop computer, smartphone, or pad computer, or on plates and components which removably engage with such devices.

### RELATED APPLICATIONS

This application claims priority to U.S. Provisional Patent Application Ser. No. 61/994,264 (Attorney Docket No. 11072.729) filed May 16, 2014, entitled DEVICE AND METHOD FOR SURFACE POSITIONING OF ANTENNAS, which is incorporated herein by reference in its entirety.

### BACKGROUND OF THE INVENTION

1. Field of the Invention

The present invention relates to antennas for transmission and reception of radio frequency communications. More particularly, it relates to a device and method for positioning antennas on surfaces encasing or surrounding an electronic device such as the rear of a flat panel display television or a laptop computer, smartphone, or pad computer, or on plates and components which removably engage with such devices.

2. Background and Related Art

Antennas provide electronic communication for radios, televisions, and cellular and smart telephones as well as other electronic devices. Further, wireless communication in the home and office has become ever more popular in recent years with the advent of Wi-Fi and Bluetooth and other high speed wireless communication modes. Such wireless communication is becoming ever more standard on devices such as so called smart televisions, DVR players, streaming video players and other network connectable audio components, and a host of other electronic items from toasters, to thermostats.

However, with the proliferation of such wireless technologies and their inclusion into electronic devices which heretofore had no network connection, a limited one, or a wired network connection, the radiating and receiving antenna elements for such devices have not kept pace. Indeed many such devices have no antenna system whatsoever or they have an antiquated antenna system, or an antenna which is only configured for a single band, and/or lacks concurrent transmission and reception abilities on multiple frequency bands used by multiple communications protocols such as Wi-Fi, Bluetooth and cellular.

Additionally, traditional televisions for off-air reception of signals have employed large rooftop or exterior antennas which require a long cable increasing signal loss, or small antennas adjacent to the television which provide a weak signal. With analog signals of the past, this signal problem was not a major issue since the signal was broadcast primarily in VHF at high power and a short loss or weak signal would have little if any effect on the picture or sound.

However, with the advent of High Definition Television, (HDTV) the television broadcast signal is now broadcast in the UHF frequency ranges sometimes at a much weaker radiated power. In such a high frequency range, a long cable will degenerate the signal from a rooftop antenna which is not greatly amplified at the source which also amplifies noise. A locally situated antenna conventionally is even smaller in size than those for VHF signals of the past, and must pick up the UHF signals through walls and windows. A very short interruption or weak signal can cause significant pixelation and loss of sound of the digital signal because so much electronic information is contained in every millisecond of the broadcast signal.

With regard to Wi-Fi and television signals, many such devices employ simple dipole antennas, and configurations of the internal antenna or antennas which fail to take into consideration of serious holes in the radiation pattern the design or antenna positioning causes. Or, because the antenna on the electronic device was an afterthought by the manufacturer, they may be ill-designed and configured for the frequency or other operational characteristics required to stream video, communicate between multiple devices, or they just have poor reception and transmission characteristics due to size and placement.

With the every more popular inclusion of wireless communication into so-called smart televisions, and pad computers and the like, such devices are expected by consumers to be networkable from the start using wired, or due to the location of such devices in the home or office, using wireless communications. Laptops and pad type computers have also evolved to include wireless communications capability to a local server or router from and to the device.

However, such smart televisions and laptops and pad computers continue to use small ineffective antennas, or such that offer poor radiation patterns for transmission and reception due to the low gain from their very small size. Or antennas which have holes in their radiation pattern and poor performance due to their positioning which may be on a perimeter edge or other area where an elongated dipole or other conventional projecting antenna may be positioned.

Further, such antennas are generally sized in a length which is a small fraction of the actual frequency expected to be employed for wireless communication. While this compact fractional sizing may provide an affinity for a frequency, using an antenna which is too small and a fraction of the radio wave intended for reception will impact performance due to poor gain. Further, many electronic components due to differing RF frequency and throughput criteria will have multiple antennas thereon and have to route signals though multiple cables to differing components.

Such low gain causes the above noted pixelation and sound problems with HDTV as noted above, and very slow throughput or bandwidth and the severe directional patterns of some such antennas easily cause weak or dropped signals or a lack of signal if the device is positioned wrongly.

Other antennas that are currently used are indoors antennas which are easy on the eyes but their size tends to make gain unrealized for producing a strong signal which yields a good throughput. The most common and effective of these indoor antennas is the well known dual dipole type positioned adjacent to or on the television receiver and affectionately referred to as “rabbit ears”. These antennas are generally ineffective for fringe area reception and are only effective for strong local signal reception. When low frequency signals reception is desired, the dipoles must be extended to their maximum length which makes the “rabbit ear” antenna susceptible to tipping over or interfering with or causing possible damage to any adjacent objects. Further, such dipole devices are ill designed for modern reception requirements of differing wireless frequencies such as those for HDTV, and local transmissions on the bluetooth and WiFi bands and lack any ability to concurrently receive and transmit on multiple frequencies such as those noted.

As such severe shortcomings continue to exist in the art of antennas being employed on or with, modern HDTV devices using digital signals packed with data as well as electronic wireless-enabled devices such as televisions and pad computers and even desktop computers. These shortcomings result in poor signal gain, directional transmission and reception, holes in the radiation pattern, slow digital throughput due to such weak or varying signals.

Thus, while techniques are currently available, challenges exist. Accordingly, it would be an improvement in the art to augment or even replace current techniques with other techniques.

### SUMMARY OF THE INVENTION

The present invention relates to antennas for transmission and reception of radio frequency communications. More particularly, it relates to a device and method for positioning antennas on surfaces encasing or surrounding an electronic device such as the rear of a flat panel display television or a laptop computer, smartphone, or pad computer, or on plates and components which removably engage with such devices.

Implementations of the present invention relate to an improved antenna element or array that is configured large enough to insure high gain for exceptional bandwidth for media and computing devices. Such a device is formed for positioning proximate to the electronic component using and transmitting an RF signal, especially with higher frequencies which are very susceptible to line loss when distance from the using device. Still further, such a device is able to send and receive RF signals on multiple bandwidths concurrently and does not have any holes in the radiation pattern. Further, such a device in addition to proximity to the device employing it, can also be adapted to change in polarization easily, and be configured to allow retrofitting of existing devices lacking a decent antenna.

The device and method herein disclosed and described provides a solution to the shortcomings in prior art in RF antennas, such as HDTV antennas and WiFi and Bluetooth antennas and the local operative engagement with electronic devices such as laptop computers, flatscreen televison, networked media communication devices and the like. It achieves the above noted goals through the provision of a wideband antenna configured for reception and broadcast, in a wideband fashion for communication of data and media and digital television, WiFi, bluetooth, and other frequencies for which it can send and receive concurrently.

The antenna element of the instant invention takes advantage of heretofore ignored areas of electronic devices for positioning larger wideband antennas. The disclosed device and method provides a means to significantly enhance signal reception and transmission from the prior art by integrating the HDTV antenna into the television hardware, along with other transmission and reception antennas if desired. Through this integration process, the antenna or antennas are actually built into the existing TV hardware.

The disclosed device and method provide this enhanced reception and transmission utility because no long cable is needed to connect the TV receiver with the antenna which as noted causes significant signal loss. Additionally, because the formed antenna is very large electrically because it takes full advantage of the large dimensional size of the television in which it is integrally formed. This large physical size has a significant radiating aperture, and thus significantly more signal gain and bandwidth than smaller conventional antennas.

The device employs a generally planar antenna element sized, spaced, and positioned for operation within or upon heretofore unused surfaces of electronic components to thereby position a high gain multi directional antenna thereon which does not suffer line loss due being highly proximate to the device being provided a signal. Further on larger flat screen displays it may be sized in a half wave configurations and other large sizes thereby yielding high gain. Still further, in a single plane of occupancy formed into or engaged upon the rear of an LCD screen or the cover therefor, a plurality of individual antennas may be formed, to provide RF signals to the various devices onboard in an RF frequency required by the device or by user choice concurrent with the reception and sending on other bands.

The antenna or plurality of antennas are formed into the metal forming the rear support for the LCD or Plasma screen, or can be formed into the surrounding housing. Alternatively the formed antenna can employ the large surface area of the planar support or the housing for the mounting of a conducting material such as copper on a dialectic substrate of such materials as MYLAR, fiberglass, REXLITE, polystyrene, polyamide, TEFLON, fiberglass or any other such material suitable for the purpose intended. The substrate may be flexible and once adhesively engaged to a position on the large metal or plastic planar member backing an LCD or Plasma display, it may employ the surface to provide a fixed or rigid positioning of the antenna.

The antenna element itself, if formed of the metal support for the screen, or into the housing surrounding it, or if formed on the substrate, can be any suitable conductive material, as for example, aluminum, copper, silver, gold, platinum or any other electrical conductive material suitable for the purpose intended. In the case of existing metal components of the electronic component such as a television, the antenna can be formed directly into the large metal structures. If formed to take advantage of the large surface areas, and be attachable, the antenna is formed of conductive material forming the element is adhered to the substrate by any known technology.

In the preferred mode of formation into the existing metal structures, a formed antenna such as a horn, as noted above, can be formed to be electrically very large in relation to existing antennas for HDTV signal reception or wireless communication. A wide bandwidth can be achieved with this large size as it depends from a much larger widest point configured for the lowest frequency received, to a narrowest point yielding the highest frequency reception.

Along a cavity pathway extending inward from the mouth defined by distal ends of the surfaces forming the antenna, the cavity narrows in cross sectional area. The cavity thus at the mouth is at a widest point between the two distal end points and narrows to a narrowest point.

In a preferred mode of the antenna herein, the cavity from this narrow point then extends in a passage to a tail portion which curves to extend to a distal end within one side portion of the formed antenna where it makes a short right angled extension from the centerline of the curving cavity. The area occupied by this tail section has a direct effect upon the antenna impedance and as such is adjusted for area for impedance matching purposes. As noted, because the area of the metal or plastic plane member supporting many LCD and Plasma displays, or the casing surrounding them, is equally as large as the display itself, the antenna herein is preferably sized to occupy a large portion of that area in a formation therewith or engagement thereto. This method of ascertaining the area of the planar support panel for a flat screen such as an LED, LCD, or Plasma screen, and crafting an engageable antenna for planar positioning thereon having one or a plurality of elements therein for RF reception in single or multiple frequencies concurrently, yields an antenna with exceptional gain. Additionally the antenna so formed is abutting the components requiring an RF signal yielding virtually no signal loss in the communication of the RF signal to and from the antennas. Further, the device herein can be configured to retrofit older devices having flat screens but lacking or having poor antennas.

In either mode of formation of such an HDTV and RF antenna using the structure of the electronic component for the antenna or an applique of an antenna thereon, a feed line connects to an input/output electrical connector port, such as a coaxial connector, to allow for engagement of transmission lines or the like. Those skilled in the art will appreciate that the electrical connector can be of any type and should therefore not be considered limited to a coaxial connector.

If the planar support panel for the LCD, LED, or Plasma screen is formed of plastic or another nonconductor or dialectic material, the antenna herein may be engaged thereon with or without a dialectic sheet of material. If the planar support panel is metal, such as aluminum or steel, the formed antennas herein are preferably formed directly into the metal structure but can be engaged on a planar piece of a dialectic on one side and the opposing side is engaged with adhesive or the like to the large planar support for the display. A secondary dialectic layer to cover and insulate the feed line on the opposite side of the substrate may be required.

The planar wideband antenna, or a plurality of wideband antennas formed into the metal of the electronic component structures, or on a metallic substrate, when so positioned into or on the rear support panel of a display screen, or on the large casing surrounding the display screen, provide an exceptionally large, and exceptionally close-in proximity RF antenna for transmission and reception on a wide band of frequencies and can also be folded or configured to operate in a plurality of polarizations.

Of course those skilled in the art will realize that cross section and length of the two side edges of the horn formed by the cavity, and the size and shape of the box-end surface area, may be adjusted to fine tune impedance matching, increase gain in certain frequencies, or for other reasons known to the skilled, and any and all such changes or alterations of the depicted antenna element as would occur to those skilled in the art upon reading this disclosure are anticipated within the scope of this invention.

It must further be noted that although the present invention is portrayed as a single antenna element in some of the drawings, or two elements formed into the structural metal material preferably, or adhered thereto, it is within the scope of the invention that the antenna be employed as an array of such antenna elements formed into the metal or positioned on the substrate, either in a vertical disposition or horizontal disposition and positionable for either horizontal or vertical polarization of RF signals received and/or broadcast.

With respect to the above description, before explaining at least one preferred embodiment of the herein disclosed antenna invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other antenna structures, and methods and systems for carrying out the several purposes of the present disclosed device. It is important, therefore, that the claims be regarded as including such equivalent construction and methodology insofar as they do not depart from the spirit and scope of the present invention.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 depicts an exploded view of a flat panel display employed for televisions, pad computers, laptops, and computer displays;

FIG. 2 shows a rear view of the antenna element device showing a first antenna formed in an upper edge and a plurality of antennas formed for other frequencies on other perimeter edges;

FIG. 3 shows another view of the device wherein a horn or multiple horn antennas formed into a conductive material engaged with a dialectic substrate;

FIG. 4 is an exemplar depiction typical of the formation and positioning of a wideband antenna directly into the metal planar component positioned behind most plasma screen and LCD displays;

FIG. 5 shows an isometric view of an example of an antenna formed into the conductive material of the planar support of a display, and showing the edges forming a wideband radiating element;

FIG. 6 depicts the antenna of FIG. 5, showing a dialectic substrate insulating a feed line for the reception and transmission of an RF signal from the formed antenna;

FIG. 7 is an overhead depiction of the antenna of FIG. 6 sowing the feed line and substrata surface; and

FIG. 8 shows the device of FIG. 7 from a perspective view.

### DETAILED DESCRIPTION OF THE INVENTION

The present invention relates to antennas for transmission and reception of radio frequency communications. More particularly, it relates to a device and method for positioning antennas on surfaces encasing or surrounding an electronic device such as the rear of a flat panel display television or a laptop computer, smartphone, or pad computer, or on plates and components which removably engage with such devices.

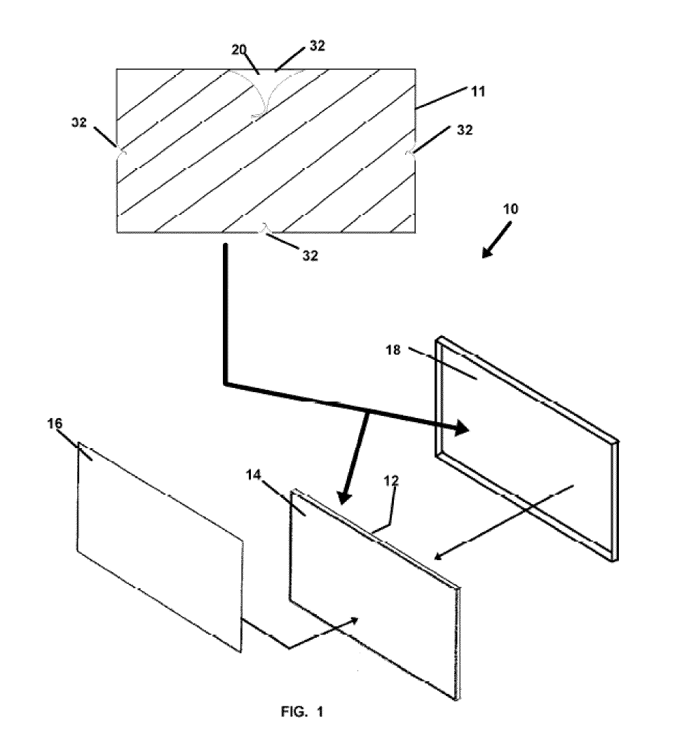

Now referring to drawings in FIGS. 1-8, wherein similar components are identified by like reference numerals, there is seen in FIG. 1 an exploded view of the method and device 10 herein disclosed as an antenna 11 and its formation into or engagement on the large planar rear surface 12 of a flatscreen display 14 which is conventionally covered by a clear screen 16 which may be a touch screen or plain glass or plastic, or the rear panel 18 covering the rear of the flatscreen display.

It is one of the primary objectives of this invention to make use of the large area of planar real estate so to speak, of the heretofore unused areas of a flat panel or flat screen display which are employed singularly or in combination with electronic components such as televisions, pad computers, laptops, and other devices.

In doing so, an antenna 11 of considerable electrical size may be operatively integrated and positioned and engaged with such an electronic component which communicates media signals for rendition on such a display. Further, formation into or on this very large area allows for the inclusion of multiple antennas 11 the same planar metal surface or adhered substrate for differing RF bands if such is desirable, instead of a single wideband antenna.

In another mode of the device herein, the antenna 11 may be formed, using a substrate 20 and adhesive 22 on an opposing surface 24 of the substrate 20, the antenna 11 may be operatively engaged at manufacture or in a retrofit of the device to enhance wireless bandwidth or off air signal reception. Such would provide significant enhancement to the operative capabilities of wireless devices in televisions, pad computers, laptops, and computer displays and other devices.

In another mode, the flatscreen display can be manufactured with the antenna 11 or antennas 11 included, and operatively engaged into the surrounding casing which may be provided for mating with connectors for cables leading to other devices which may need an antenna for television signals, WiFi, bluetooth, or cellular signals or the like.

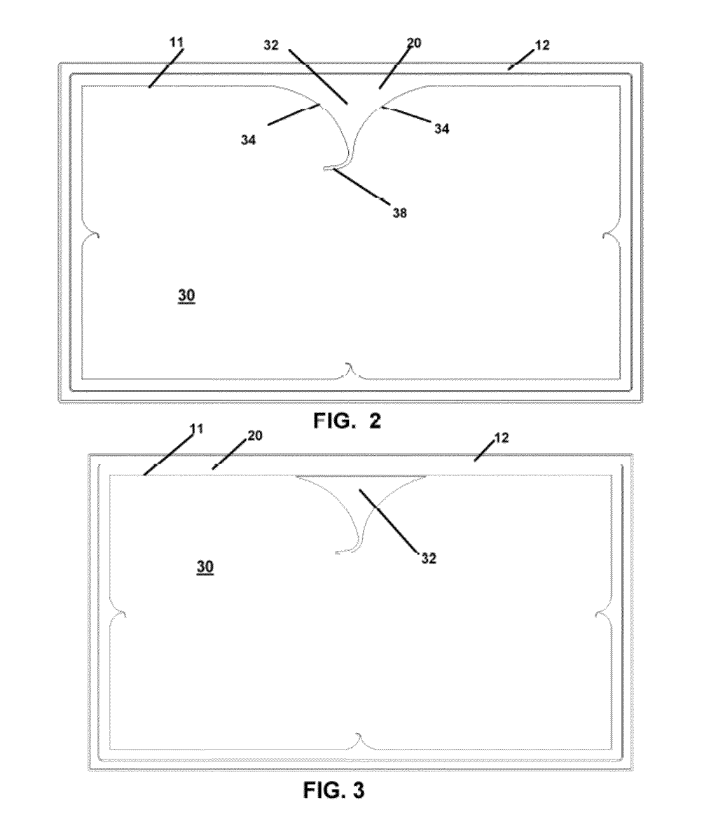

In FIG. 2 is shown an overhead view of the antenna 11 formed into conductive material 30 on a substrate 20. In a particularly preferred embodiment, the planar antenna 11 has an element formed in the conductive planar material on a first side of the substrate 20 through the formation of one or a plurality of voids 32 in the conductive material 30. Each has opposing curved side edges 34 forming a mouth or horn which declines in diameter from a widest point along the edge of the conductive material 30 and curving toward a center line of the void 32 defining the mouth of an element of the antenna 11. At a narrowest gap between the opposing side edges 34 a cavity curves away from the center of the void 32 or mouth, in a curved or serpentine extension where a pickup and feed line engage.

In all modes of the device and method herein, the void 32 and the edges 34 define a mouth or horn is configured at a widest point to operatively receive and transmit on a lowest frequency received, and curve to decline the distance between the side edges 34 to the narrowest point of the mouth or horn which is configured to send and receive RF at the highest frequency.

As shown in FIGS. 2 and 3, one or a plurality of horns or voids 32 formed in the conductive material 30 can be formed to yield transmission and reception capabilities in different bands or frequencies such as WiFi, Bluetooth, and cellular for example, or in differing polarization orientations.

Along a cavity or pathway 38 extending away from the horn or mouth defined by the side edges 34, at their narrowest point of separation, feed lines and pickups can be placed for RF reception and communication to and from the antenna 11. The area of the pathway 38 may be elongated or enlarged for impedance matching purposes.

FIGS. 4-6 are exemplars of a particularly favored mode of the device and method herein, where formation and positioning of an antenna 11 is integral with or formed directly into conductive material 30 defined by the metal planar component positioned behind most plasma screen and LCD flat screen display 14. Shown also are the side edges 34 forming a mouth 32 therebetween which extend from distal corners to a narrowest separation wherein a pathway 38 extends away from the void or mouth 32 defined by the side edges 34. As noted this configuration forms a very large radiating element proximate to the electronic device and provides a significant signal gain and very short delivery path.

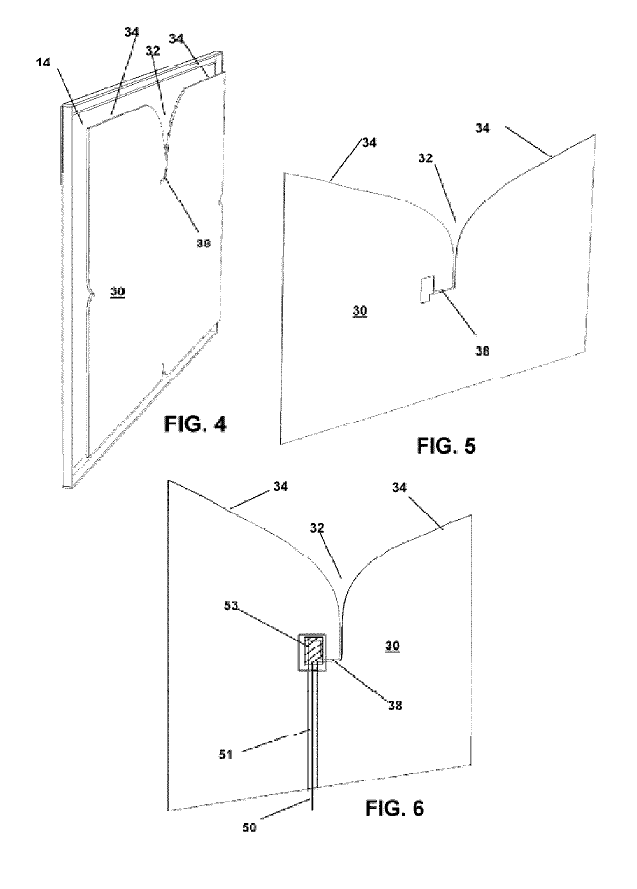

FIG. 5 shows an isometric view of an antenna formed directly into the conductive material 30 of the planar support of a display as in FIG. 4. Another view of the device of FIGS. 4 and 5 is shown in FIG. 6, which also depicts a feed line 50 running along a dialectic substrate 51 to a pickup 53 on the antenna 11.

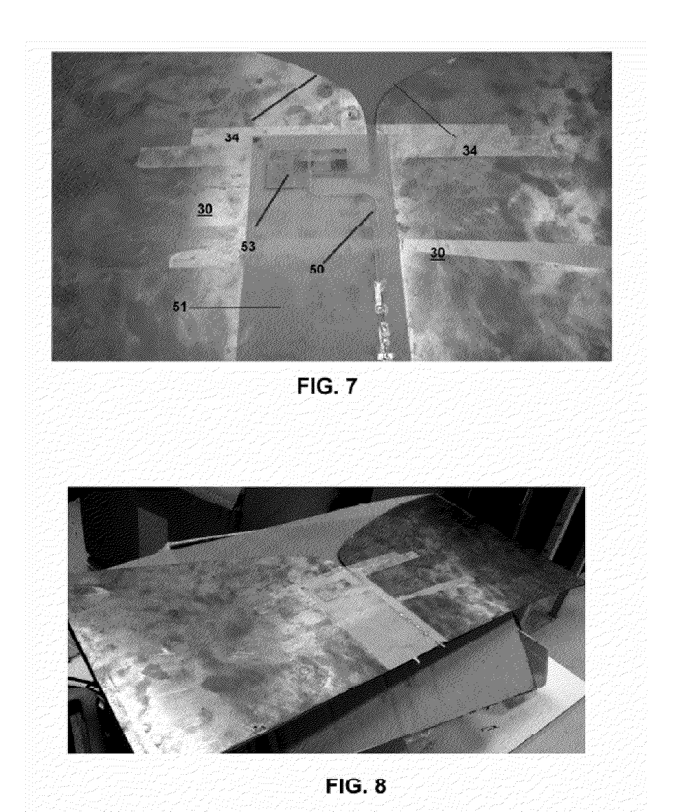

FIGS. 7 and 8 are embodiments of the method and device herein similar to that of FIGS. 4-6.

While all of the fundamental characteristics and features of the surface mounted antenna system and method herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Thus, as discussed herein, the embodiments of the present invention embrace antennas for transmission and reception of radio frequency communications. More particularly, it relates to a device and method for positioning antennas on surfaces encasing or surrounding an electronic device such as the rear of a flat panel display television or a laptop computer, smartphone, or pad computer, or on plates and components which removably engage with such devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An antenna element formed into the large conductive metal surface supporting the rear of a flat screen display.

2. A method for the formation of an antenna by forming voids communicating through the planar support surface at the rear of a plasma or liquid crystal video display.
